(19) United States
(12) Patent Application Publication
(10) Pub. No.: US 2014/0315616 A1
(43) Pub. Date: Oct. 23, 2014

(54) Slot Machine Style Game with Player Selected Game Symbols

(71) Applicant: AVCOM, INC., Marlboro, NJ (US)

(72) Inventors: Jeremy A. Avin, Marlboro, NJ (US); Brian D. Swift, Brooklyn, NY (US)

(73) Assignee: Avcom, Inc., Marlboro, NJ (US)

(21) Appl. No.: 13/866,580

(22) Filed: Apr. 19, 2013

(51) Int. Cl. G07F 17/34

(52) U.S. Cl. CPC G07F 17/34
USPC 463/20

(57) ABSTRACT

A method for a slot machine style game is disclosed. The method includes the steps of determining an outcome of the slot machine style game and displaying a plurality of game symbols corresponding to the outcome. At least one of the game symbols is a symbol selected by a player. The method also includes the steps of determining whether at least a portion of the plurality of game symbols is a winning combination and, when there is a winning combination, determining a first award associated with the winning combination.

### FIELD

The present invention relates to games of chance, wagering games, and gaming methods and devices. More particularly, the present invention relates to a slot machine style game with game symbols that may be selected by a player.

### BACKGROUND

A slot machine generally comprises a plurality of rotatable reels controlled by a processor. Early slot machines used mechanically rotatable reels, while newer machines use video reels. In response to a wager, the processor randomly selects an outcome from a plurality of possible outcomes and then causes the reels to be rotated and stopped to display the selected outcome. The selected outcome is represented by symbols on the reels. If the selected outcome corresponds to a winning combination identified on a pay table, then the processor instructs a payout mechanism to award a payout for that winning combination to the player in the form of coins, tokens, credits, or other thing of value to the player.

Games that increase player interest are more valuable. In the case of casino-based slot machines, increased player interest results in more money being wagered, and consequently more revenue to the casino. For slot machine style games in which an award is something other than money, increased player interest results in more sharing of game experiences with friends, downloads by interested players, and activity on the game. Thus, any feature that makes games, including slot machine style games, more enticing to players is desirable for the game owner.

Different symbols in a slot machine style game lead to different awards and can also affect the other symbols on the screen. For example, a wild symbol in slot machine style games substitutes for other symbols in order to complete winning combinations. Another type of wild symbol acts only as a wildcard substitution for a specific subset of other symbols. Still another type of wild symbol may transform all other symbols of a specific subset into wild symbols.

Slot machine style games in which a player may select symbols that are included in the game do not exist and, therefore, player excitement is limited. Indeed, customizing game symbol interactions through player-selected symbols would allow a player to craft their own game experience. Thus, when a player-selected symbol appears, player anticipation and excitement is maximized.

A need exists for slot machine style games wherein the player can select one or more symbols that are to be part of the game. In this manner, upon waiting to see or actually seeing these player-selected symbols appear in the game, the player experiences increased anticipation and excitement.

### SUMMARY

One embodiment of the present disclosure is directed to a method for a slot machine style game. It includes the steps of determining an outcome of the slot machine style game and displaying a plurality of game symbols corresponding to the outcome. According to this embodiment, at least one of the game symbols is a symbol selected by a player. The method also includes the steps of determining whether at least a portion of the plurality of game symbols is a winning combination and, when there is a winning combination, determining a first award associated with the winning combination.

A second embodiment of the present disclosure relates to a method for a slot machine style game. It includes the steps of receiving a request to begin the slot machine style game and determining whether the request is valid. When the request is determined to be valid, the method includes the steps of determining an outcome of the slot machine style game and determining a plurality of game symbols to be displayed. According to this embodiment at least one of the game symbols is a symbol selected by a player. The method also includes the steps of determining whether at least a portion of the plurality of game symbols is a winning combination and, when there is a winning combination, determining a first award associated the winning combination.

Other embodiments of the disclosed slot machine style game will become apparent from the following detailed description, the accompanying drawings and the appended claims.

### BRIEF DESCRIPTION OF THE DRAWINGS

FIG. 1 is a hardware block diagram of an embodiment of the slot machine style game of the present disclosure.

FIG. 2 is a software flow diagram of an embodiment of the slot machine style game of the present disclosure.

FIG. 3 is a hardware block diagram of another embodiment of the slot machine style game of the present disclosure.

FIG. 4 is software a flow diagram of another embodiment of the slot machine style game of the present disclosure.

FIGS. 5A-5C are exemplary screen sequences of an embodiment of the slot machine style game of the present disclosure.

### DETAILED DESCRIPTION

In the following detailed description of exemplary embodiments, reference is made to the accompanying drawings, which form a part hereof, and in which is shown by way of illustration specific exemplary embodiments in which the invention may be practiced. These embodiments are described in sufficient detail to enable those skilled in the art to practice the invention, and it is to be understood that other embodiments may be utilized and that logical, mechanical, electrical, software, processing, and other changes may be made without departing from the spirit or scope of the present invention. The following detailed description is, therefore, not to be taken in a limiting sense, and the scope of the present invention is defined only by the appended claims.

In traditional slot machine style games, a plurality of symbols are displayed in order to build a winning combination. The present disclosure improves on such traditional games, adding to player excitement, by permitting the player to select which symbols will be included in the game.

The slot machine style game of the present disclosure may be played in a controlled environment, such as a physical or online casino. In this case, the award provided to a player is typically money or its equivalent. The subject game may also be played in a non-controlled environment, such as an internet game where the award may be points or something else of value.

The slot machine style game of the present disclosure may be implemented on a variety of hardware and software platforms. In one embodiment, the game is implemented as an app or other program on a smart phone, such as Apple's iPhone. It is to be understood that this is but one implementation; the game may also be implemented on a video slot machine, traditional mechanical slot machine, or other processor-based system, such as a tablet computer, laptop computer, or desktop computer.

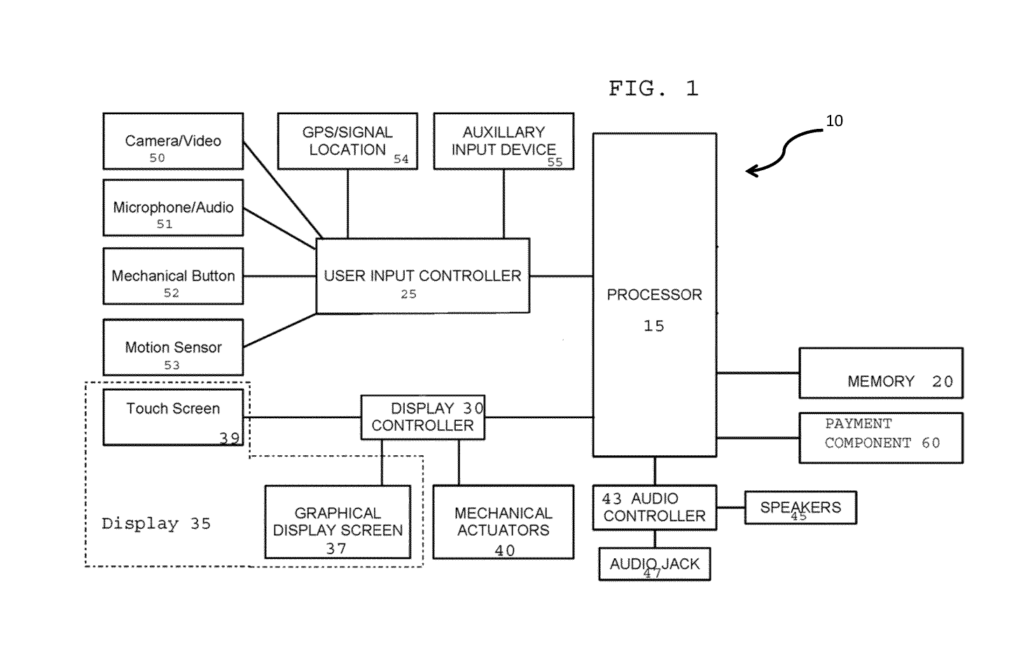

FIG. 1 illustrates the functional hardware units in one embodiment. A gaming device 10, such as a smart phone, includes processor 15, memory 20, display controller 30, and display 35.

In this embodiment, display 35 includes graphical display 37 and a touch screen 39. Graphical display 37 displays a plurality of game symbols to a player, preferably in a multitude of pay lines. Such symbols may include bells, hearts, fruits, numbers, letters, cards, bars, player selected symbols, and any other game symbols.

In this embodiment, graphical display 37 also displays means to enable player input. For example, a player may use buttons or other images to select games symbols that are to be included in the game. In addition, they may indicate a number of payout lines to be included in a game and a number of coins to be wagered for each payout line. A button or virtual lever may also be displayed to actuate a game. Graphical display 37 also may be configured to display the total current wager and the total amount of awards won by a player.

Touch screen 39 allows for player interaction with the buttons and other images on graphical display 37. It emulates mechanical buttons, allowing for pressing, toggling, or other activation that transmits user interaction. A player makes decisions and inputs signals into gaming device 10 by touching the touch screen 39 at the appropriate places. Thus, a player uses the displayed buttons to indicate a number of payout lines to be included in a game, a number of coins to be wagered for each payout line, and their selection of symbols to be included in the game. The player may touch a button to activate a game.

Display controller 30 is in communication with display 35, touch screen 39, and processor 15. It receives commands from touch screen 39 and outputs to graphical display 37 in response to commands received from processor 15.

Display controller 30 may also be in communication with one or more actuators 40, such as mechanical actuators. These include elements that cause device 10 to vibrate and/or to fire a flash of a camera that is part of gaming device 10. In exemplary use, when a player wins a game, processor 15 may communicate with display controller 30 to cause the device 10 to vibrate and/or toggle the flash on and off.

In one embodiment, processor 15 manages and processes user inputs and causes display of game outcomes and awards. In an exemplary embodiment, processor 15 determines game outcomes, which will include player-selected symbols as part of a winning combination, and causes awards to be provided to a player.

Processor 15 is in communication with memory 20. Memory 20 stores program code and instructions, executable by processor 15, to execute the slot machine style game and control gaming device 10. Memory 20 also stores other data such as image data, event data, player input data, random number generators, pay-table data or other operating data, information and applicable game rules that relate to the play of the slot machine style game. Memory 20 may include random access memory (RAM), read only memory (ROM), flash memory and/or EEPROM (electrically erasable programmable read only memory). Any other suitable magnetic, optical and/or semiconductor memory may be used with the device 10.

In one embodiment, an audio controller 43, in communication with processor 15, is used for outputting audio signals to audio outputs, such as speakers 45 or an audio jack 47.

In one embodiment, device 10 includes a user input controller 25, which is in communication with and may accept a signal from one or more input components 50-55 to actuate or otherwise provide data to the slot machine style game. User input controller 25 communicates with processor 15 to process the inputs.

A camera/video component 50 captures images and/or video that may contain a player's gestures or other expressions and sends that data, via user input controller 25, to processor 15 for interpretation and action. In one exemplary embodiment, camera/video component 50 may capture a player simulating the arm of a traditional slot machine being pulled. The data representing the image or video is sent, via user input controller 25, to processor 15, which may actuate the slot machine style game.

A microphone/audio component 51 captures speech or other audio that may contain commands or be subject to other interpretive action. Data representing the speech or other audio is transmitted to processor 15 for interpretation and action via user input controller 25. In an exemplary embodiment, a slot machine style game may be actuated when the user says “SPIN” into the microphone. Similarly, when particular audio (for example, a song or other sound) is detected, the slot machine style game may be actuated.

A mechanical button or switch 52 on device 10 may be used to actuate the slot machine style game. For example, when a user presses, toggles, or activates the button 52 (for example, the volume increment button on an iPhone), the slot machine style game may be actuated.

A motion sensor component 53 captures movement, motion, acceleration, or other gyroscopically determinant values of device 10. Component 53 sends the corresponding data, via user input controller 25, to processor 15 for interpretation and action. Thus, for example, a player may waive device 10 from left to right to actuate the slot machine style game.

A GPS or other location detector 54 may be used to determine the location of device 10 as a variable. The location is transmitted to processor 15 via user input controller 25 for interpretation and action. Thus, when processor 15 determines that a player is in a designated location, the slot machine style game may be actuated and/or augmented. For example, when processor 15 determines that a player is in a gift shop of a casino, the award multiplier associated with the multiwild symbol may be increased.

An auxiliary input device 55 may be used to allow for physical, virtual, or other interactions that can be interpreted by device 10. In one embodiment, when input device 55 is a joystick connected to a smart phone, for example Apple's iPhone, the player can toggle the joystick to simulate a slot machine handle, which is interpreted by the input controller 25 as a game actuation request.

In embodiments in which money is wagered, a payment component 60 may be placed in communication with processor 15. Component 60 may be used to provide awards to the player or accept payment from a player. The awards may be in the form of money (e.g., cash, debit) or an equivalent thereof. Such equivalents include tokens, ticket, note, voucher, credits, and the like.

In a traditional slot machine embodiment, payment component 60 may include a coin or token slot or bill acceptor. A player can thus place coins in the coin slot or paper money, tickets, notes or vouchers into the bill acceptor.

In other embodiments, devices such as readers or validators for credit cards, debit cards, data cards or credit slips could be used for accepting payment. In one embodiment, a player may insert an identification card into a card reader of the gaming device. An identification card is a smart card having a programmed microchip or a magnetic strip coded with a player's identification, credit totals and other relevant information. In other embodiments, money may be transferred to a gaming device through electronic funds transfer. When a player funds the gaming device 10, the processor determines the amount of funds entered and the corresponding amount is shown on the credit or other suitable display as described herein.

As described above, in one embodiment, memory 20 stores program code and instructions, executable by processor 15, to execute the slot machine style game and control gaming device 10. Processor 15 executes the program code in response to player or other interactions to perform the following steps of process 200.

At step 205, a player selects one or more symbols to be included as part of the total game symbol set for the slot machine style game. The player may depress, actuate, or otherwise initiate these selections. The screen or display mode on which the selection is made may differ from the screen or display mode used for displaying a plurality of game symbols (described below).

The player-selected symbols may have associated requirements. Absent a player meeting such requirements, a symbol may not be selected. Such requirements may include a player's account balance, frequency of game play by the player, or other characteristics associated with the player.

The player-selectable symbols may vary in their properties and/or function. For example, a certain player-selectable symbol may cost more to purchase than other player-selectable symbols. This may be because it offers a higher award value, has enhanced functionality in the way it augments other displayed symbols, or for some other reason. Further, player-selectable symbols that cost the same amount may differ in the way they augment other displayed symbols. Of course, player-selectable game symbols may be provided without charge to a player.

At step 210, a slot machine style game is actuated. In one embodiment, actuation occurs when a player touches his/her finger on touch screen 39. The user may pull a lever, depress a spin button, or otherwise indicate that they would like a game to commence. In an alternate embodiment, actuation occurs based on an input from an input component 50-55 (FIG. 1).

At step 215, processor 15 randomly selects an outcome from a plurality of possible outcomes and thus determines a plurality of corresponding game symbols to be displayed and the locations on the reels to display such symbols. In a preferred embodiment, a player-selected symbol is part of the plurality of game symbols to be displayed. As is well known, the frequency by which certain game symbols and combinations thereof are displayed is proportional to the likelihood of different award eventualities. Processor 15 causes virtual reels shown on graphical display 37 to rotate and display the plurality of game symbols. When the reels stop, processor 15 causes the graphical display 37 to show the resulting plurality of symbols. Such symbols may include bells, hearts, fruits, numbers, letters, cards, bars, player-selected symbols, and any other game symbols.

At step 220, processor 15 determines whether at least one of the plurality of symbols displayed at step 215 is a player-selected symbol. If it is not, then processing continues at step 230. If there is a player-selected symbol, processing continues at step 225.

At step 225, processor 15 initiates an augmentation routine on graphical display 37 to transform or otherwise augment the game. In one embodiment, for a particular player-selected symbol, certain symbols that are part of the symbols displayed at step 215 are transformed into different symbols. This augmentation may replace, or be superimposed over, all or a part of the symbols that are part of the plurality of symbols displayed at step 215.

Displaying the transformed symbols as part of the plurality of symbols displayed at step 215 provides a significant feature of the present disclosure. Indeed, the anticipation of whether a player-selected symbol will appear, which player selected symbol will appear, and what effect it will have on the game play creates the excitement that the player is strategically enhancing their gaming experience and in effect creating their own slot machine style game.

In an exemplary embodiment, processor 15 randomly (which herein includes pseudo-randomly) generates game outcomes, includes player-selected symbols as part of a winning combination, and causes awards to be provided to a player. The award may be based on criteria such as the location of the player's device 10, time of day, day of the week, or other known quantifiable values for the player, like their age. In another embodiment, criteria dependent on previous play, such as, rate of game play, wager amount, special occasions known to the system, or any other precise or augmentable value a particular game instance may make known about the player.

At step 230, for each active pay line, processor 15 determines whether such pay line includes a winning combination. In one embodiment, the slot machine style game makes more pay lines available as a player progresses in the game. Special symbols can also be used to unlock extra pay lines for the subsequent spins.

The determination of whether such pay line includes a winning combination is done in a traditional manner, wherein a player-selected symbol either exists as part of a winning combination or constitutes a winning scenario by inclusion in the resulting game symbols, regardless of position in a winning or non-winning symbol combination. If a winning combination is not present, then process 200 ends at step 255, where processor 15 waits for the next actuation. If a winning combination is present, then processing continues at step 232.

At step 232, processor 15 calculates the amount of a base award without regard to whether a player-selected symbol may enhance a payout. The base award may be determined from a payout table stored in memory 20.

At step 235, for the winning pay line, processor 15 determines whether such pay line includes a player-selected symbol. If it does not, then processing continues at step 250 where the base award is provided to the player. If it does, then at step 240, processor 15 then calculates an augmented award. The augmented award may be based on symbol(s) that were transformed, replaced, or superimposed at step 225. These new symbols may, in preferred embodiments, have values which differ from the symbols that were replaced. Thus, an original award may be augmented based on the new value of the symbols.

At step 245, processor 15 may initiate a prize animation sequence and provide the augmented award to the player. The augmented award may be money, in the form of coins, tokens, credits. It may also be another thing of value to the player, such as points that the player is accumulating during play of the game. In one embodiment, processor 15 uses graphical display 37 to alert the player that he/she has won and to display the amount of the augmented award. Processor 15 updates the total amount won by a player on graphical display 37. In another embodiment, processor 15 instructs display controller 35 to vibrate and/or to fire a flash of a camera that is part of device 10.

Processing may then end at step 255, where processor 15 waits for the next actuation.

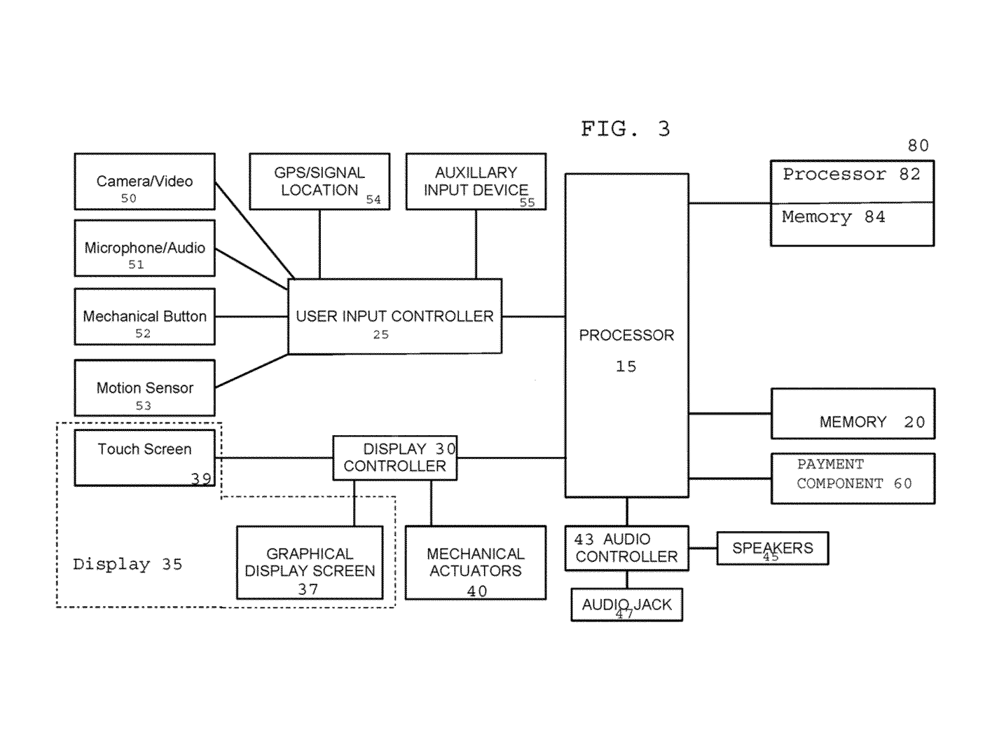

FIG. 3 shows the slot machine style game in an alternate distributed processing environment. Like reference numerals in FIG. 3 correspond to those in FIG. 1. In this embodiment, a gaming server or other network processor 80 may be used to determine game outcomes and symbols to be displayed, including the player-selected symbols, generate base and augmented awards, and transmit such information so it can be provided to a player.

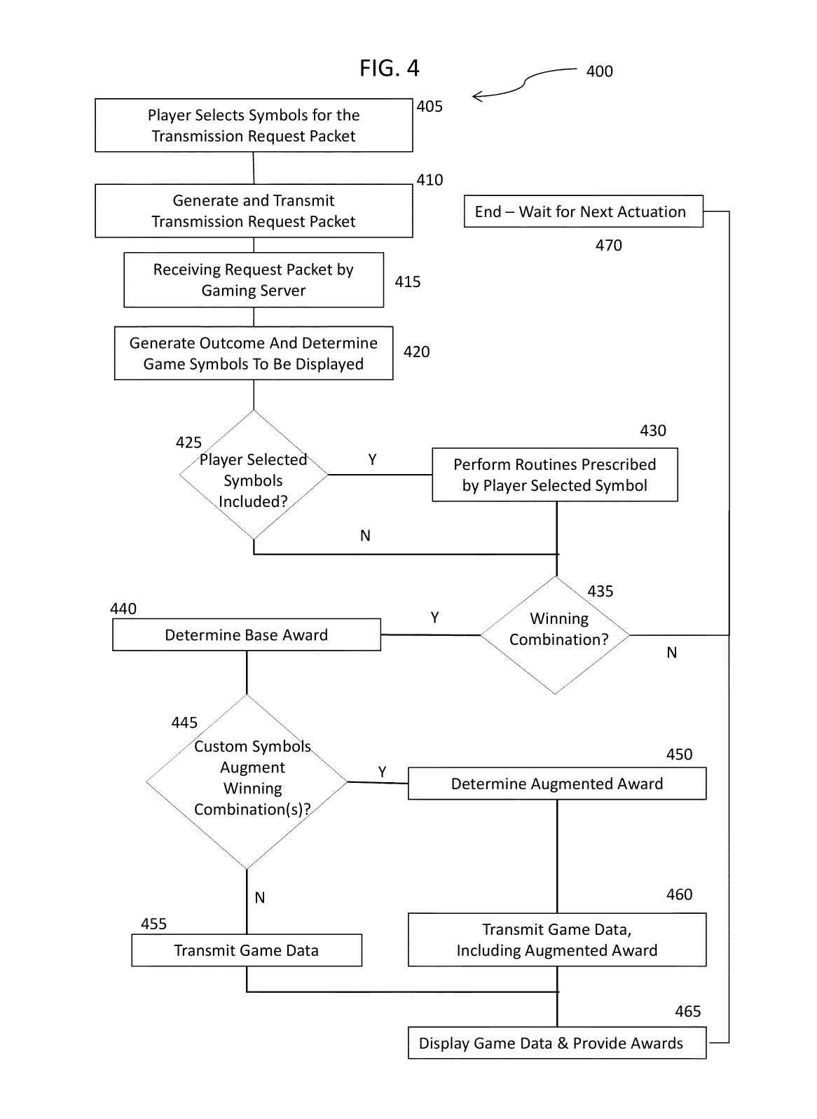

The gaming server 80 includes a processor 82 and memory 84. Memory 84 stores program code and instructions, executable by processor 80, to execute the slot machine style game and communicate with device 10. In one embodiment, processor 82 executes program code in response to player input communicated from gaming device 10 to perform the steps of process 400 of FIG. 4.

At step 405, a player selects one or more symbols to be included as part of the total game symbol set for the slot machine style game. The player may depress, actuate, or otherwise initiate these selections. The player-selectable symbols may vary in their properties and/or function. For example, a certain player-selectable symbol may cost more to purchase than other player-selectable symbols. This may be because it offers a higher award value, has enhanced functionality in the way it augments other displayed symbols, or for some other reason. Further, player-selectable symbols that cost the same amount may differ in the way they augment other displayed symbols. Of course, player-selectable game symbols may be provided without charge to a player. References to the player-selected symbols are made available to the transmission request packet and are sent to the network processor 80.

At step 410, processor 15 of a gaming device 10 generates a transmission request packet. In one embodiment, processor 15 compiles and packages credentialing data for gaming device 10 and the associated player. The credentialing data may include, for example, a unique device identification number, a unique hardware profiling, an authorization token received during setup, the player's username, phone number, password, or some combination thereof of these identifiers. Some or all of this data may serve as authentication credentials for the gaming device 10.

At step 415, processor 15 confirms the integrity of the transmission request packet. Thus, processor 15 determines that the data is complete and meets the protocol formatting requirements for gaming server 80. In one embodiment, processor 15 may also determine whether a player qualifies or is otherwise permitted, based on a plurality of restrictions, such as game credit/money balance, to include their selected symbols in the game.

At step 420, processor 82 randomly selects an outcome from a plurality of possible outcomes. Processor 82 determines a plurality of corresponding game symbols to be displayed and the locations on the reels to display such symbols. As above, the symbols may include bells, hearts, fruits, numbers, letters, cards, bars, player-selected symbols, and other game images. The game symbols corresponding to the selected outcome will later be transmitted to processor 15 for display.

At step 425, processor 82 determines whether at least one of the game symbols determined by processor 82 at step 415 is a player-selected symbol. If it is not, then processing continues at step 435. If there is a player selected symbol, processing continues at step 430.

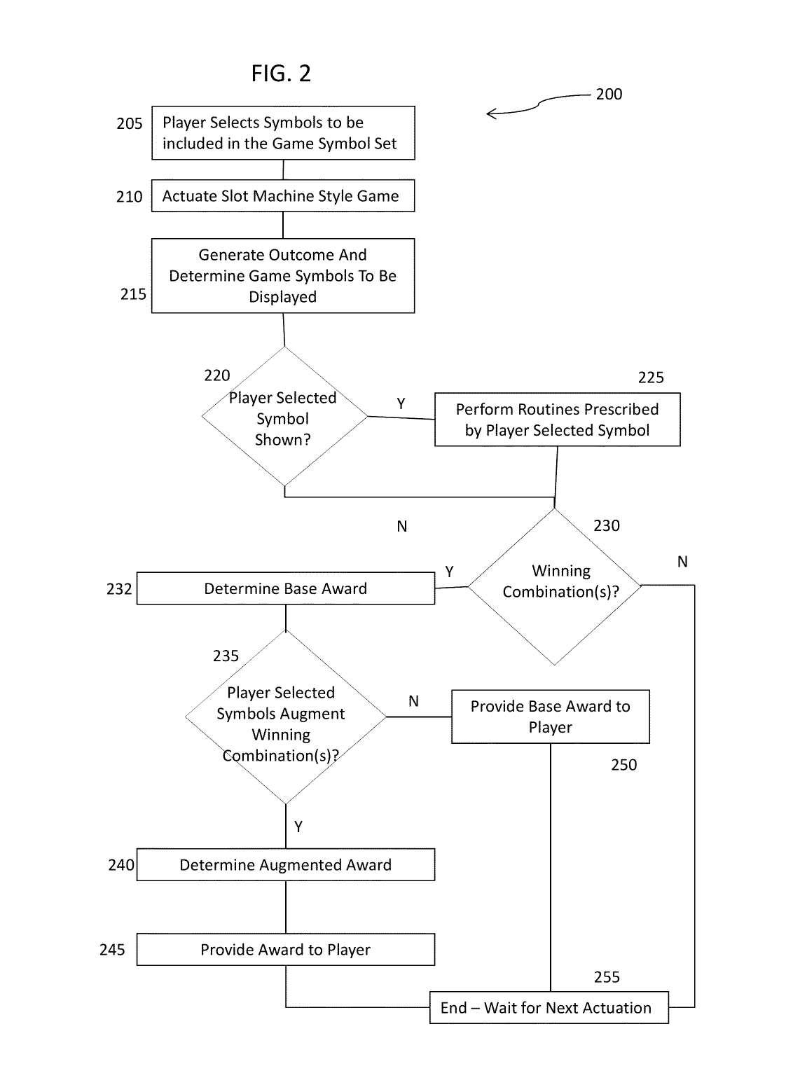

At step 430, processor 82 performs any augmentation routines associated with the player-selected symbol. The augmentation criteria may be based on criteria such as those describe above (FIG. 2, step 225).

At step 435, for each active pay line, processor 82 determines whether such pay line includes a winning combination. This is done as described above. If a winning combination is not present, then process 400 ends at step 470, where processor 15 waits for the next actuation. If a winning combination is present, then processing continues at step 440.

At step 440, processor 82 calculates the amount of a base award without regard to whether a player-selected symbol may enhance a payout. The base award may be determined from a payout table stored in memory 84.

At step 445, for the winning pay line, processor 82 determines whether such pay line includes a player-selected symbol. If it does not, then processing continues at step 455 where processor 82 transmits the plurality of game symbols and the base award to the gaming device 10. If it does, then at step 450, processor 82 then calculates an augmented award. The augmented award may be based on symbol(s) that were transformed, replaced, or superimposed at step 430. These new symbols may, in preferred embodiments, have values which differ from the symbols that were replaced. Thus, an original award may be augmented based on the new value of the symbols. Processor 82 transmits the plurality of game symbols, the augmented game outcome, the base award, and the augmented award to the gaming device 10 at step 460.

At step 465, processor 15 executes a prize animation sequence and displays the plurality of game symbols, any augmentation routines, the base award, and the augmented award to player. Process 400 ends at step 470, where processor 15 waits for the next actuation.

Similar to process 200, the animation sequence is displayed graphical display 37 to transform or otherwise augment the game experience. In one embodiment, for a particular player-selected symbol, certain symbols that are part of the symbols displayed at step 420 are transformed into different symbols. This augmentation may replace, or be superimposed over, all or a part of the symbols that are part of the plurality of symbols displayed at step 420.

Displaying the transformed symbols as part of the plurality of symbols displayed provides a significant feature of the present disclosure. Indeed, the anticipation of whether a player selected symbol will appear, which player selected symbol will appear, and what effect it will have on the game play creates the excitement that the player is strategically enhancing their gaming experience and in effect creating their own slot machine style game.

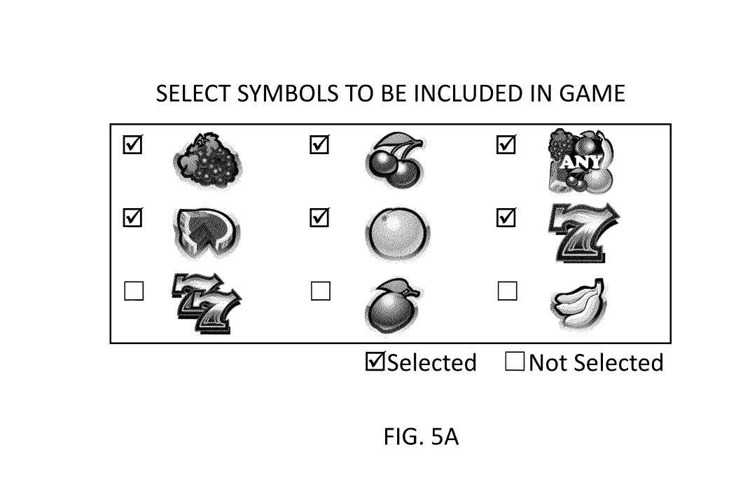

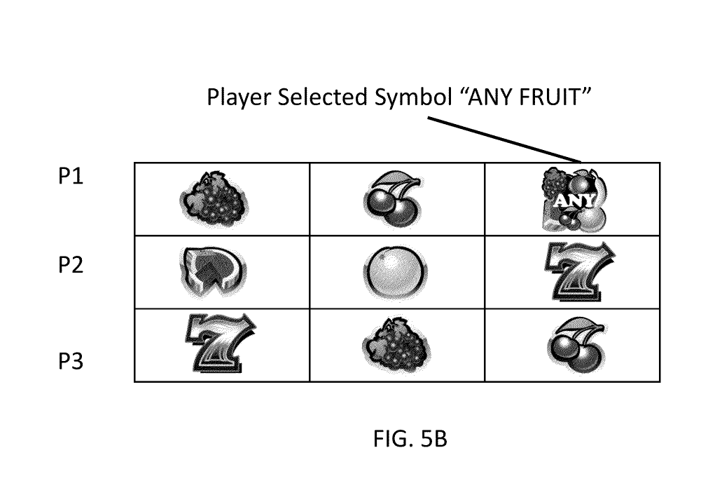

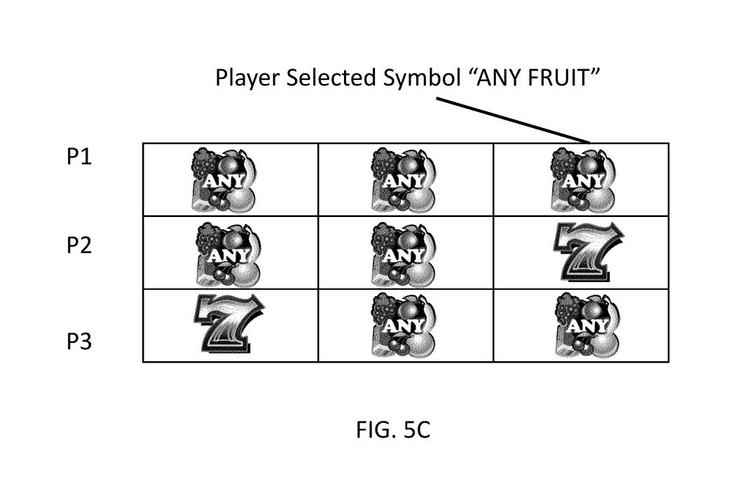

FIGS. 5A-5C are exemplary screen sequences and will serve to illustrate an example of the slot machine style game of the present disclosure.

A player selects a plurality of symbols to be included in their slot machine style game, where some may be restricted, or where selectable symbols may vary in cost or effect. The player may depress a virtual checkbox on touch screen 39 to select the symbols. Processor 15 determines whether player is permitted to include the player-selectable symbols and alerts user to restrictions or allows the inclusion of player-selected symbols in the game.

As shown in FIG. 5A, display 37 shows a plurality of symbols that the player may include in the game, as exemplified by a symbol coupled with some form of selection indicator, in this case a checkbox. Other variations include depressing the symbol and observing a highlighted or augmented state via display 37, and other methods for actuation and selection indication.

A player wagers $5 and actuates the slot machine style game, for example, by pulling a virtual lever on touch screen 39. Processor 15 randomly selects an outcome from a plurality of possible outcomes and thus determines a plurality of corresponding game symbols to be displayed and the locations on the reels to display such symbols. Processor 15 causes virtual reels shown on graphical display 37 to rotate and display the plurality of game symbols. When the reels stop, processor 15 causes the graphical display 37 to show the resulting plurality of symbols. As shown in FIG. 5B, display 37 shows three horizontal pay lines: P1 shows GRAPES-CHERRY-ANY FRUIT; P2 shows WATERMELON-ORANGE-SEVEN; and P3 shows SEVEN-GRAPES-CHERRY.

Processor 15 determines that at least one of the plurality of symbols displayed is the player-selected symbol, here, symbol “ANY FRUIT” in FIG. 5B. Processor 15 initiates an animation sequence on graphical display 37. As shown in FIG. 5C, processor 15 transforms all other fruit symbols into “ANY FRUIT”—acting now as wild symbols to each other.

For each active pay line, here P1-P3, processor 15 determines that pay line P1 depicts a winning combination. The determination is done in a traditional manner, wherein a player-selected symbol either exists as part of a winning combination or constitutes a winning scenario by inclusion in the resulting game symbols, regardless of position in a winning or non-winning symbol combination. In this case, player-selected symbol “ANY FRUIT” appears in the third position of P1. Although this symbol is not part of a traditional winning combination, because it was included in the resulting game symbols, its augmentation routines are eligible for activation.

Processor 15 calculates the amount of a base award for the game symbol combinations, prior to performing any augmentation routines. The base award may be determined from a payout table stored in memory 20.

Processor 15 performs instructed augmentation routines for any player-selected symbols present and transmits these effects to display 37.

For the winning pay line P1, processor 15 determines that it now includes 3 “ANY FRUIT” symbols following the augmentation routine. Processor 15 calculates an augmentation award, for example, by treating each “ANY FRUIT” as a wild fruit symbol with maximum fruit symbol value. Thus, the augmented award would be $30 if the maximum value for a 3 fruit combination was $30.

Processor 15 initiates a prize animation sequence and provides the augmentation award to the player—for example, by adding points to the player's account.

Although various embodiments of the disclosed slot machine style game have been shown and described, modifications may occur to those skilled in the art upon reading the specification. The present application includes such modifications and is limited only by the scope of the following claims.

We claim:

1. A method for a slot machine style game, comprising the steps of:
a. determining an outcome of the slot machine style game;
b. displaying a plurality of game symbols corresponding to the outcome, wherein at least one of the game symbols is a symbol selected by a player;
c. determining whether at least a portion of the plurality of game symbols is a winning combination; and
d. when there is a winning combination, determining a first award associated with the winning combination.

2. The method of claim 1, further comprising the steps of
a. performing an augmentation routine associated with the player-selected symbol to transform at least some of the displayed plurality of game symbols;
b. determining a second award based on the first award and the result of the augmentation routine;
c. providing the second award to a player.

3. The method of claim 1, further comprising the step of selecting, by a player, symbols that are to be included in the slot machine style game.

4. The method of claim 3, wherein the step of selecting occurs on a screen or display mode that differs from a screen or display mode used for displaying a plurality of game symbols in step 1(b).

5. The method of claim 1, wherein the player-selected symbols have requirements associated therewith, and wherein the player-selected symbols may be selected only when the requirements are met.

6. The method of claim 5, wherein the player-selected symbols requirements include at least one of account balance, frequency of game play by player, and criteria associated with the player.

7. The method of claim 2, further comprising, after step 2(b), transforming the player-selected symbols into different symbols.

8. The method of claim 7, wherein the step of transforming comprises changing the displayed symbols, either by augmentation or replacement, and displaying the transformed symbol.

9. The method of claim 1, wherein steps 1(a) and 1(c) are carried out on a first device, and the step 1(b) is carried out on a second device, wherein the first device differs from the second device.

10. The method of claim 1, further comprising the step of actuating the slot machine style game using an input selected from the group consisting of a touch screen input, a motion sensor, a mechanical button, a microphone, a camera, and an auxiliary input device.

11. The method of claim 1, wherein the player has a location associated therewith, further comprising the steps of
a. increasing the second award based on the location of the player; and
b. displaying the increased second award to the player.

12. The method of claim 1, wherein the player plays the slot machine style game on a device, wherein the device has a camera with a flash associated therewith, further comprising the step of lighting or toggling the flash when the plurality of game symbols is a winning combination.

13. The method of claim 1, wherein the player plays the slot machine style game on a device, wherein the device has a camera with a flash associated therewith, wherein the device vibrates when the plurality of game symbols is a winning combination.

14. The method of claim 2, wherein the step of providing the second award to the player comprises displaying the second award to the player or updating an account associated with the player.

15. The method of claim 2, wherein the step of providing the second award to the player comprises providing money or an equivalent thereof to the player.

16. A method for a slot machine style game, comprising the steps of:
a. receiving a request to begin the slot machine style game and determining whether the request is valid;
b. when the request is determined to be valid,
i. determining an outcome of the slot machine style game;
ii. determining a plurality of game symbols to be displayed, wherein at least one of the game symbols is a symbol selected by a player;
iii. determining whether at least a portion of the plurality of game symbols is a winning combination; and
iv. when there is a winning combination, determining a first award associated with the winning combination.

17. The method of claim 16, further comprising the steps of
a. performing an augmentation routine associated with the player-selected symbols;
b. determining a second award based on the first award and the result of the augmentation routine;
c. providing the second award to a player.

18. The method of claim 17, wherein the step 17(c) comprises transmitting the plurality of game symbols, the results of the augmentation routine, the first award, and the second award to a device associated with a player.
